(19) United States
(12) Patent Application Publication
(10) Pub. No.: US 2026/0134865 A1
(43) Pub. Date: May 14, 2026

(54) DELIMITER INSERTION DEVICE AND SPEECH RECOGNITION SYSTEM

(71) Applicant: NTT DOCOMO, INC., Tokyo (JP)

(72) Inventor: Kengo TAKETANI, Chiyoda-ku (JP)

(73) Assignee: NTT DOCOMO, INC., Tokyo (JP)

(21) Appl. No.: 18/875,751

(22) PCT Filed: May 10, 2023
(86) PCT No.: PCT/JP2023/017568

§ 371 Date: Dec. 17, 2024

(30) Foreign Application Priority Data
Aug. 5, 2022 (JP) 2022-125544

(51) Int. Cl. G10L 15/04; G10L 15/16

(52) U.S. Cl. CPC G10L 15/04; G10L 15/16

(57) ABSTRACT

A delimiter insertion device includes an inter-word time acquisition unit that acquires an inter-word time, which is the length of time until a next word is spoken for each word included in the uttered speech; and a delimiter insertion unit that inserts a delimiter into a target text, which is a text obtained by speech recognition of the uttered speech, based on a delimiter insertion model and the inter-word time. The delimiter insertion model outputs delimiter prediction information indicating a delimiter in response to the input of a delimiter-removed sentence. The delimiter insertion unit inserts a delimiter into the target text based on delimiter prediction information obtained by inputting the target text to the delimiter insertion model.

### TECHNICAL FIELD

The present invention relates to a delimiter insertion device and a speech recognition system.

### BACKGROUND ART

A technique for inserting a punctuation mark into the text obtained by speech recognition is known. For example, Patent Literature 1 discloses a technique for inserting a punctuation mark into the text using an engine trained with training data in the form of statistically punctuated text.

### CITATION LIST

### Patent Literature

Patent Literature 1: Japanese Unexamined Patent Publication No. 2012-508903

### SUMMARY OF INVENTION

### Technical Problem

In a typical speech recognition engine, a text including a string of words is acquired from uttered speech, and then a delimiter such as a punctuation mark is inserted at an appropriate position as a sentence. When a delimiter is inserted by referring only to text information, the insertion position of the delimiter may differ from the speaker's intention even though the insertion position is not incorrect as a sentence.

Therefore, the present invention has been made in consideration of the above problem, and it is an object of the present invention to insert a delimiter at a position intended by the speaker for the text obtained by speech recognition processing on uttered speech.

### Solution to Problem

In order to solve the aforementioned problem, a delimiter insertion device according to an aspect of the present disclosure is a delimiter insertion device for inserting a delimiter to separate a sentence after a word included in a text obtained by speech recognition of uttered speech, and includes: an inter-word time acquisition unit that acquires an inter-word time, which is a length of time until a next word is spoken for each word included in the uttered speech; and a delimiter insertion unit that inserts a delimiter into a target text, which is a text obtained by speech recognition of the uttered speech, based on a delimiter insertion model and the inter-word time. The delimiter insertion model is a model that receives at least a delimiter-removed sentence, which is a sentence not including the delimiter, as an input, and outputs delimiter prediction information indicating a delimiter to be inserted after each word included in the delimiter-removed sentence and that is generated by machine learning using training data including a pair of the delimiter-removed sentence and a delimiter-included sentence, which is a sentence including a delimiter. The delimiter insertion unit inserts a delimiter into the target text based on the delimiter prediction information that is obtained by inputting the target text to the delimiter insertion model as the delimiter-removed sentence and has been adjusted according to the inter-word time.

According to the aspect described above, the inter-word time in the uttered speech is acquired. The inter-word time reflects the speaker's intention when speaking. Then, the delimiter prediction information, which is obtained by inputting the target text to the delimiter insertion model and which is adjusted according to the inter-word information, is acquired. Since the delimiter prediction information acquired herein is information adjusted according to the inter-word time of each word in the uttered speech, the delimiter prediction information indicates delimiters reflecting the speaker's intention. Then, by inserting delimiters into the target text based on the delimiter prediction information, it is possible to obtain the text in which delimiters are inserted at positions according to the speaker's intention.

### Advantageous Effects of Invention

It is possible to insert a delimiter at a position intended by the speaker for the text obtained by speech recognition processing on uttered speech.

### BRIEF DESCRIPTION OF DRAWINGS

FIG. 1 is a block diagram showing the functional configuration of a delimiter insertion device according to an embodiment of the present invention.

FIG. 2 is a hardware block diagram of the delimiter insertion device.

FIG. 3 is a diagram for explaining a problem to be solved by the delimiter insertion device according to the present embodiment.

FIG. 4 is a diagram showing target text acquisition processing.

FIG. 5 is a diagram showing a first example of training data used for machine learning of a delimiter insertion model.

FIG. 6 is a diagram showing a first example of the configuration of a delimiter insertion model.

FIG. 7 is a diagram showing an example of adjustment rule information that is referenced for adjusting delimiter prediction information based on the inter-word time.

FIG. 8 is a diagram showing an example of processing for adjusting delimiter prediction information.

FIG. 9 is a diagram showing an example of inter-word correction processing.

FIG. 10 is a diagram showing a second example of training data used for machine learning of the delimiter insertion model.

FIG. 11 is a diagram showing a second example of the configuration of a delimiter insertion model.

FIG. 12 is a diagram showing a third example of training data used for machine learning of the delimiter insertion model.

FIG. 13 is a functional block diagram showing an example of the configuration of a speech recognition system according to the present embodiment.

FIG. 14 is a flowchart showing the processing content of a delimiter insertion method in the delimiter insertion device.

FIG. 15 is a diagram showing the configuration of a delimiter insertion program.

### DESCRIPTION OF EMBODIMENTS

Embodiments of a delimiter insertion device and a speech recognition system according to the present invention will be described with reference to the diagrams. In addition, whenever possible, the same portions are denoted by the same reference numerals, and repeated descriptions thereof will be omitted.

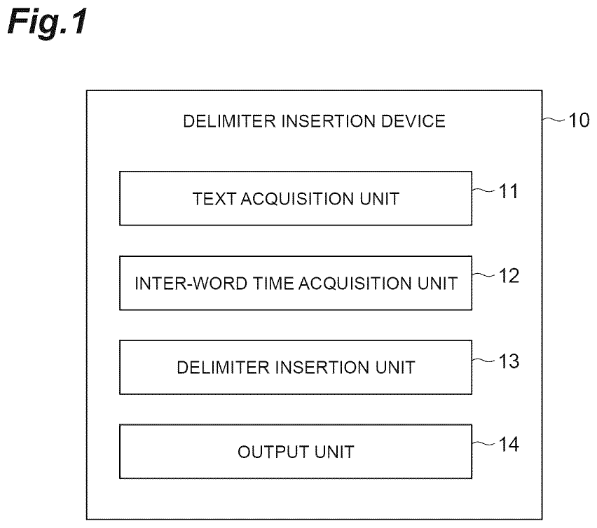

FIG. 1 is a diagram showing the functional configuration of a delimiter insertion device according to the present embodiment. The delimiter insertion device according to the present embodiment is a device that inserts a delimiter for separating a sentence after words included in text obtained by speech recognition of uttered speech.

In the present embodiment, a case in which a delimiter insertion device 10 inserts a period, a comma, and a question mark, which are delimiters inserted into English sentences, into text including English sentences will be described as an example. However, the present invention is not limited to the example. The delimiter insertion device 10 may be a device that inserts delimiters, such as periods and commas, into Japanese sentences, or may be a device that inserts delimiters in other languages into sentences of the other languages.

As shown in FIG. 1, the delimiter insertion device 10 functionally includes a text acquisition unit 11, an inter-word time acquisition unit 12, a delimiter insertion unit 13, and an output unit 14. These functional units 11 to 14 may be configured in one device, or may be configured in a distributed manner in a plurality of devices.

In addition, the block diagram shown in FIG. 1 shows blocks in functional units. These functional blocks (configuration units) are realized by any combination of at least one of hardware and software. In addition, a method of realizing each functional block is not particularly limited. That is, each functional block may be realized using one physically or logically coupled device, or may be realized by connecting two or more physically or logically separated devices directly or indirectly (for example, using a wired or wireless connection) and using the plurality of devices. Each functional block may be realized by combining the above-described one device or the above-described plurality of devices with software.

Functions include determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but are not limited thereto. For example, a functional block (configuration unit) that makes the transmission work is called a transmitting unit or a transmitter. In any case, as described above, the implementation method is not particularly limited.

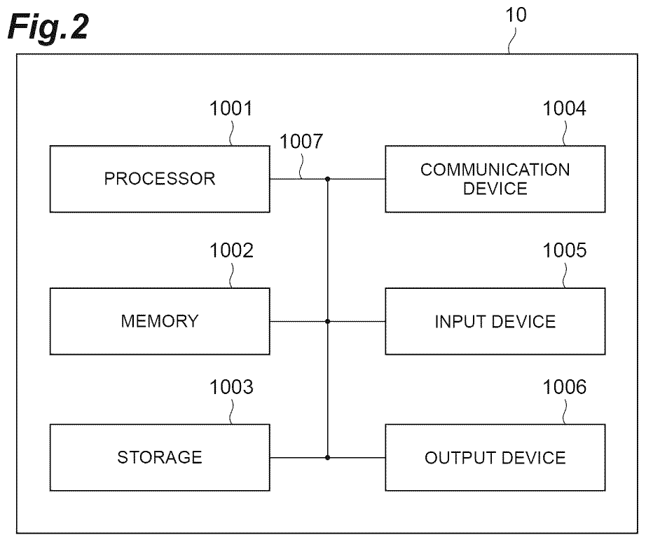

For example, the delimiter insertion device 10 according to an embodiment of the present invention may function as a computer. FIG. 2 is a diagram showing an example of the hardware configuration of the delimiter insertion device 10 according to the present embodiment. The delimiter insertion device 10 may be physically configured as a computer device including a processor 1001, a memory 1002, a storage 1003, a communication device 1004, an input device 1005, an output device 1006, a bus 1007, and the like.

In addition, in the following description, the term “device” can be read as a circuit, a unit, and the like. The hardware configuration of the delimiter insertion device 10 may include one or more devices for each device shown in the diagram, or may not include some devices.

Each function of the delimiter insertion device 10 is realized by reading predetermined software (program) onto hardware, such as the processor 1001 and the memory 1002, so that the processor 1001 performs a calculation and controlling communication by the communication device 1004 or controlling the reading and/or writing of data in the memory 1002 and the storage 1003.

The processor 1001 controls the entire computer by operating an operating system, for example. The processor 1001 may be a central processing unit (CPU) including an interface with peripheral devices, a control device, a calculation device, a register, and the like. For example, each of the functional units 11 to 14 shown in FIG. 1 may be realized by the processor 1001.

In addition, the processor 1001 reads a program (program code), a software module, or data into the memory 1002 from the storage 1003 and/or the communication device 1004, and executes various kinds of processing according to these. As the program, a program causing a computer to execute at least a part of the operation described in the above embodiment is used. For example, each of the functional units 11 to 15 of the delimiter insertion device 10 may be realized by a control program that is stored in the memory 1002 and executed by the processor 1001. Although it has been described that the various kinds of processes described above are executed by one processor 1001, the various kinds of processes described above may be executed simultaneously or sequentially by two or more processors 1001. The processor 1001 may be implemented by one or more chips. In addition, the program may be transmitted from a network through a telecommunication line.

The memory 1002 is a computer-readable recording medium, and may be configured by at least one of, for example, a ROM (Read Only Memory), an EPROM (Erasable Programmable ROM), an EEPROM (Electrically Erasable Programmable ROM), and a RAM (Random Access Memory). The memory 1002 may be called a register, a cache, a main memory (main storage device), and the like. The memory 1002 can store a program (program code), a software module, and the like that can be executed to implement a pseudo data generation method and a sentence generation method according to an embodiment of the present disclosure.

The storage 1003 is a computer-readable recording medium, and may be configured by at least one of, for example, an optical disk such as a CD-ROM (Compact Disc ROM), a hard disk drive, a flexible disk, and a magneto-optical disk (for example, a compact disk, a digital versatile disk, and a Blu-ray (Registered trademark) disk), a smart card, a flash memory (for example, a card, a stick, a key drive), a floppy (registered trademark) disk, and a magnetic strip. The storage 1003 may be called an auxiliary storage device. The storage medium described above may be, for example, a database including the memory 1002 and/or the storage 1003, a server, or other appropriate media.

The communication device 1004 is hardware (transmitting and receiving device) for performing communication between computers through a wired and/or wireless network, and is also referred to as, for example, a network device, a network controller, a network card, and a communication module.

The input device 1005 is an input device (for example, a keyboard, a mouse, a microphone, a switch, a button, and a sensor) for receiving an input from the outside. The output device 1006 is an output device (for example, a display, a speaker, and an LED lamp) that performs output to the outside. In addition, the input device 1005 and the output device 1006 may be integrated (for example, a touch panel).

In addition, respective devices, such as the processor 1001 and the storage device 1002, are connected to each other by the bus 1007 for communicating information. The bus 1007 may be configured using a single bus, or may be configured using a different bus for each device.

In addition, the delimiter insertion device 10 may include hardware, such as a microprocessor, a digital signal processor (DSP), an ASIC (Application Specific Integrated Circuit), a PLD (Programmable Logic Device), and an FPGA (Field Programmable Gate Array), and some or all of the functional blocks may be realized by the hardware. For example, the processor 1001 may be implemented using at least one of these hardware components.

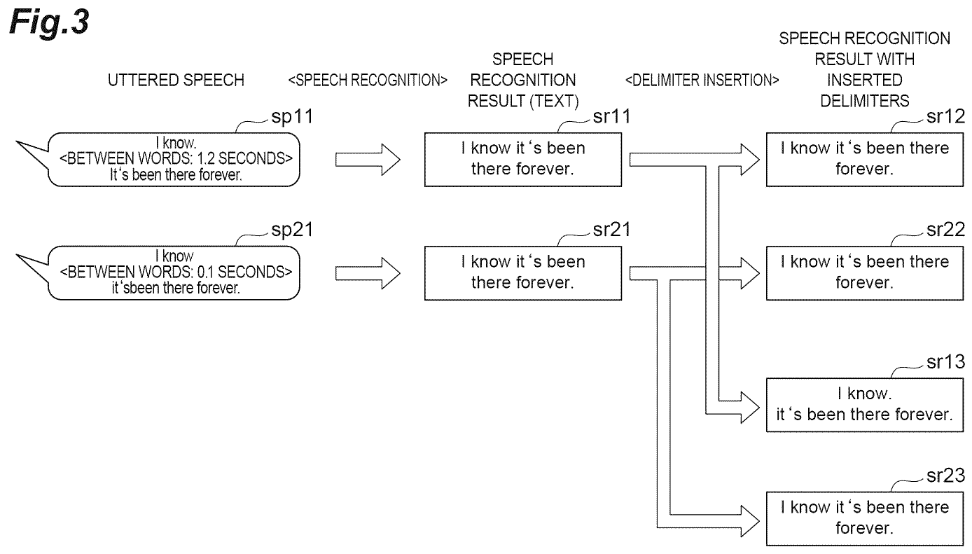

The problem to be solved by the delimiter insertion device 10 according to the present embodiment will be described with reference to FIG. 3. Uttered speeches sp11 and sp21 shown in FIG. 3 are uttered by speakers with different intentions. Speech recognition results sr11 and sr21 obtained by speech recognition of the uttered speech sp11 and sp21 are the same text “I know it's been there forever”. In the uttered speech sp11, the inter-word time until the word next to the word “know” is uttered is 1.2 seconds. On the other hand, in the uttered speech sp21, the inter-word time until the word next to the word “know” is uttered is 0.1 seconds.

In conventional delimiter insertion technology, a delimiter is inserted at an appropriate position as a sentence in the text obtained as a speech recognition result. Therefore, speech recognition results sr12 and sr22 obtained by inserting delimiters into the speech recognition results sr11 and sr21 using the conventional delimiter insertion technology are the same even though the original uttered speech is different.

The speech recognition result sr22 has a period after the word “forever” as intended by the speaker of the uttered speech sp21. On the other hand, the speech recognition result sr12 has a period after the word “forever” even though the uttered speech sp11 was intended to have a period inserted after the word “know”. The position of this period is different from the position intended by the speaker.

The delimiter insertion device 10 according to the present embodiment inserts a delimiter using the inter-word time in the uttered speech. Therefore, the delimiter insertion device 10 inserts a period after each of the word “know” and the word “forever” for the speech recognition result sr11 obtained based on the uttered speech sp11, thereby obtaining a speech recognition result sr13. On the other hand, the delimiter insertion device 10 inserts a period after the word “forever” for the speech recognition result sr21 obtained based on the uttered speech sp21, thereby obtaining a speech recognition result sr23. The speech recognition results sr13 and sr23 have delimiters at positions intended by the speakers of the uttered speech sp11 and sp21.

Next, each functional unit of the delimiter insertion device 10 will be described. The text acquisition unit 11 acquires a target text, which is a text into which a delimiter is to be inserted. The target text is a text obtained by speech recognition of uttered speech. The inter-word time acquisition unit 12 acquires the inter-word time, which is the length of time until the next word is uttered for each word included in the uttered speech.

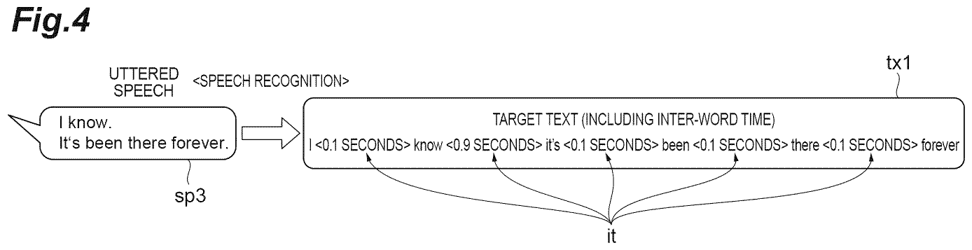

FIG. 4 is a diagram showing an example of acquiring a target text and the inter-word time. The text acquisition unit 11 acquires a target text tx1 “I know it's been there forever” based on uttered speech sp3. The text acquisition unit 11 may acquire the target text by performing speech recognition of uttered speech using known speech recognition processing technology or other technologies.

The inter-word time acquisition unit 12 acquires, as an inter-word time it, the length of time until the next word is uttered for each word included in the target text. The inter-word time acquisition unit 12 may acquire, as the inter-word time it, a silence time during speech recognition of the uttered speech sp3. The silence time is, for example, a time during which the volume is less than a predetermined level. In addition, the inter-word time acquisition unit 12 may sequentially acquire a speech recognition result each time speech recognition is performed from a speech recognition engine used for speech recognition of uttered speech, and may acquire an update time interval as the inter-word time it by regarding the time interval between acquisition and updating of the speech recognition result as a pseudo-silence time between the occurrences of words.

The delimiter insertion unit 13 inserts a delimiter into the target text based on the delimiter insertion model and the inter-word time. Specifically, the delimiter insertion unit 13 inserts a delimiter into the target text based on delimiter prediction information obtained by inputting the target text to the delimiter insertion model. The delimiter prediction information includes information adjusted according to the inter-word time.

The delimiter insertion model receives at least a delimiter-removed sentence, which is a sentence that does not include a delimiter, and outputs delimiter prediction information indicating a delimiter to be inserted after each word included in the delimiter-removed sentence. In addition, the delimiter insertion model is generated by machine learning using training data including pairs of delimiter-removed sentences and delimiter-included sentences, which are sentences including delimiters.

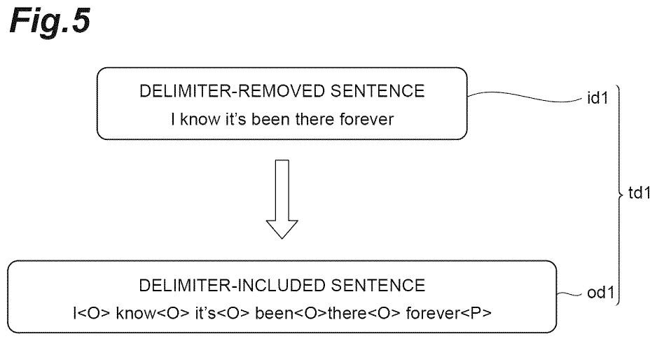

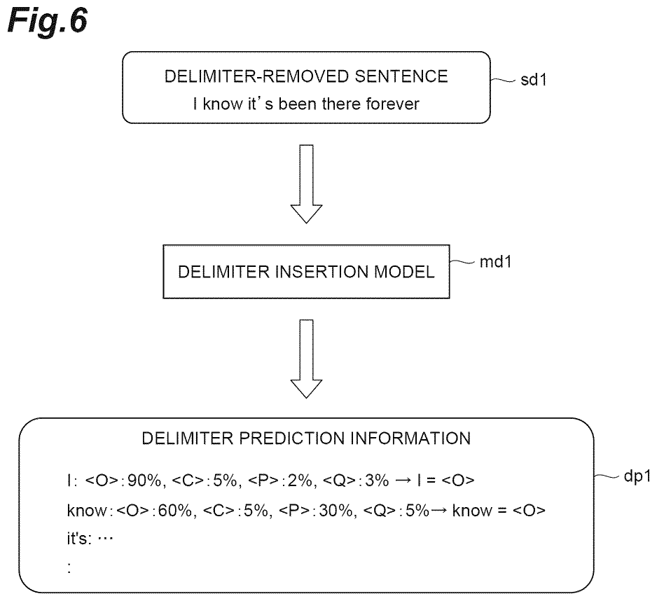

FIG. 5 is a diagram showing a first example of training data used for machine learning of the delimiter insertion model. FIG. 6 is a diagram showing a first example of the configuration of the delimiter insertion model.

As shown in FIG. 5, training data td1, which is an example of training data used for machine learning of a delimiter insertion model md1, includes a pair of a delimiter-removed sentence id1 and a delimiter-included sentence od1.

The delimiter-included sentence od1 includes a string of words that make up the sentence and delimiter labels that are labels indicating delimiters to be inserted after the respective words. The labels indicating delimiters are schematically shown in FIG. 5 and the like as follows.
<O> . . . No delimiter
<P> . . . Period
<C> . . . Comma
<Q> . . . Question mark

The delimiter-removed sentence id1 may be a sentence obtained by removing the delimiter labels from the delimiter-included sentence od1.

In machine learning of the delimiter insertion model md1, the delimiter-removed sentence id1 is input to the delimiter insertion model md1 in the learning process, and the weights, parameters, and the like that make up the delimiter insertion model md1 are updated based on the error between the output obtained from the delimiter insertion model md1 and the delimiter-included sentence od1, which is teacher data.

As shown in FIG. 6, the trained delimiter insertion model md1 outputs delimiter prediction information dp1 in response to the input of a delimiter-removed sentence sd1.

The delimiter insertion model md1 may be a model including a neural network. More specifically, the delimiter insertion model md1 may be configured as a sequence labeling model that solves the sequence labeling task of predicting a delimiter to be inserted after each word included in the input sentence.

The delimiter insertion model md1, which is a model including a trained neural network, can be read or referenced by a computer, and can be regarded as a program that causes the computer to execute predetermined processing and the computer to realize a predetermined function.

That is, the trained delimiter insertion model md1 of the present embodiment is used in a computer including a CPU and a memory. Specifically, in response to an instruction from the trained delimiter insertion model md1 stored in the memory, the CPU of the computer operates to perform a calculation on the input data input to the input layer of the neural network based on the trained weighting coefficients (parameters), response functions, and the like corresponding to each layer and to output the result (probability) from the output layer.

The delimiter prediction information dp1 includes a symbol insertion likelihood, which is the likelihood of various delimiters that may be inserted after each word included in the delimiter-removed sentence sd1, and a symbol absence likelihood, which is the likelihood of no delimiter being inserted after each word. Then, based on the maximum likelihood of the symbol insertion likelihood and the symbol absence likelihood, a determination (labeling) is made as to whether to insert one of a plurality of kinds of delimiters after each word or insert no delimiter after each word.

The delimiter prediction information dp1 illustrated in FIG. 6 includes the symbol insertion likelihood and the symbol absence likelihood of each delimiter for the word “I” as follows.

$$< O > : 90 \% , < C > : 5 \% , < P > : 2 \% , < Q > : 3 \%$$

Therefore, since the symbol absence likelihood of no delimiter being inserted (label <O>) is the maximum, the word “I” is labeled with the label <O> of no delimiter.

Similarly, the delimiter prediction information dp1 includes the symbol insertion likelihood and the symbol absence likelihood of each delimiter for the word “know” as follows.

$$< O > : 60 \% , < C > : 5 \% , < P > : 30 \% , < Q > : 5 \%$$

Therefore, since the symbol absence likelihood of no delimiter being inserted (label <O>) is the maximum, the word “know” is labeled with the label <O> of no delimiter.

As an example of adjustment of delimiter prediction information using inter-word time, the delimiter insertion unit 13 may adjust the delimiter prediction information output from the delimiter insertion model based on the inter-word time. Specifically, the delimiter insertion unit 13 may adjust the symbol insertion likelihood and the symbol absence likelihood included in the delimiter prediction information based on the inter-word time.

When the inter-word time of one of words included in the target text is a first time, the delimiter insertion unit 13 may adjust the symbol absence likelihood for the one word to be increased and/or adjust the symbol insertion likelihood of at least one kind of delimiter, among a plurality of kinds of delimiters, for the one word to be decreased. When the inter-word time of the one word is a second time longer than the first time, the delimiter insertion unit 13 may adjust the symbol insertion likelihood of at least one kind of delimiter, among a plurality of kinds of delimiters, for the one word to be increased and/or adjust the symbol absence likelihood for the one word to be increased.

Then, based on the maximum likelihood of the adjusted symbol insertion likelihood and symbol absence likelihood, the delimiter insertion unit 13 inserts one of the plurality of kinds of delimiters after the word, or does not insert a delimiter.

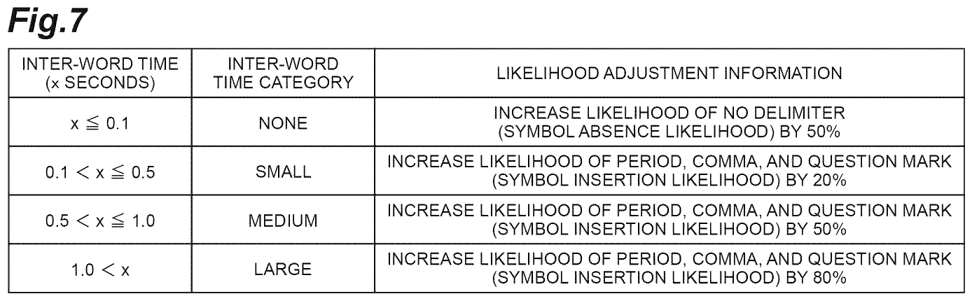

In order to adjust the symbol insertion likelihood and the symbol absence likelihood in this manner, the delimiter insertion unit 13 may adjust the likelihood with reference to adjustment rule information, for example. FIG. 7 is a diagram showing an example of adjustment rule information that is referred to in order to adjust delimiter prediction information based on the inter-word time. The adjustment rule information may be stored in a storage means accessible by the delimiter insertion unit 13, or may be provided as a table in the delimiter insertion unit 13.

As shown in FIG. 7, the adjustment rule information is information in which an inter-word time category indicating the length of the inter-word time and likelihood adjustment information indicating the adjustment content of the likelihood are associated with each range of inter-word time. For example, when the inter-word time (x) is equal to or less than 0.1 seconds, the inter-word time category is “none”, and the adjustment rule specifies that the likelihood adjustment is to “increase the symbol absence likelihood by 50%”. In addition, when the inter-word time (x) is longer than 0.5 seconds and equal to or less than 1.0 seconds, the inter-word time category is “medium”, and the adjustment rule specifies that the likelihood adjustment is to “increase the symbol insertion likelihood by 50%”.

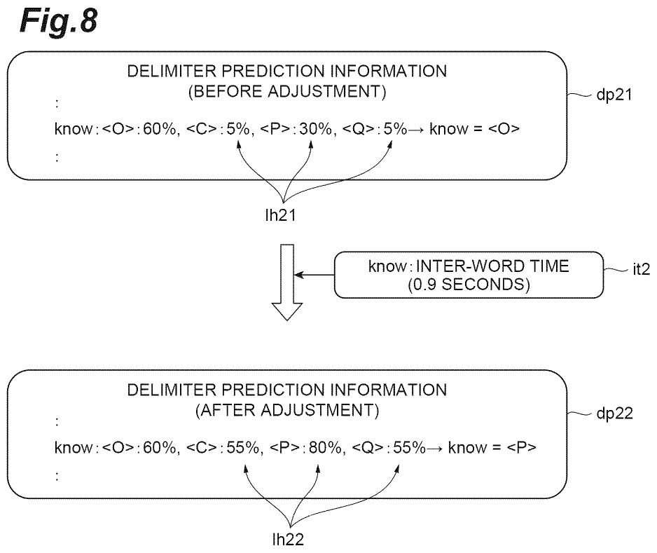

FIG. 8 is a diagram showing an example of processing for adjusting delimiter prediction information. Delimiter prediction information dp21 shown in FIG. 8 indicates a part of delimiter prediction information before adjustment processing that is output from the delimiter insertion model md1.

The delimiter prediction information dp21 includes the symbol insertion likelihood lh21 and the symbol absence likelihood of each delimiter for the word “know”. According to the delimiter prediction information dp21 before adjustment, since the symbol absence likelihood of no delimiter being inserted (label <O>) is the maximum, the word “know” is labeled with the label <O> of no delimiter.

The delimiter insertion unit 13 adjusts the likelihood of each piece of the delimiter prediction information dp21 based on the inter-word time it2 of the word “know”. Specifically, since the inter-word time it2 of the word “know” acquired by the inter-word time acquisition unit 12 is 0.9 seconds, the delimiter insertion unit 13 acquires likelihood adjustment information “increase the symbol insertion likelihood of a period, a comma, and a question mark by 50%” associated with the inter-word time of 0.9 seconds with reference to the adjustment rule information (FIG. 7), and adjusts the symbol insertion likelihood lh21 of a comma, a period, and a question mark according to the acquired likelihood adjustment information.

Then, the delimiter insertion unit 13 increases each value of the symbol insertion likelihood lh21 by 50% to acquire adjusted delimiter prediction information dp22. In the delimiter prediction information dp22, since the symbol insertion likelihood of the period (label <P>) is the maximum, the delimiter insertion unit 13 labels the word “know” with the label <P> of the delimiter “period”. Then, the delimiter insertion unit 13 inserts a period after the word “know” included in the target text based on the labeled label <P>.

In this manner, a relative adjustment is made such that the symbol insertion likelihood increases and/or the symbol absence likelihood decreases as the inter-word time of one word included in the target text increases, and a relative adjustment is made such that the symbol insertion likelihood decreases and/or the symbol absence likelihood increases as the inter-word time of one word decreases. Therefore, the speaker's intention is reflected in the symbol insertion likelihood and the symbol absence likelihood. Then, based on the adjusted symbol insertion likelihood and symbol absence likelihood, the delimiter is inserted or not inserted. Therefore, it is possible to obtain a text in which delimiters are inserted at appropriate positions according to the speaker's intention.

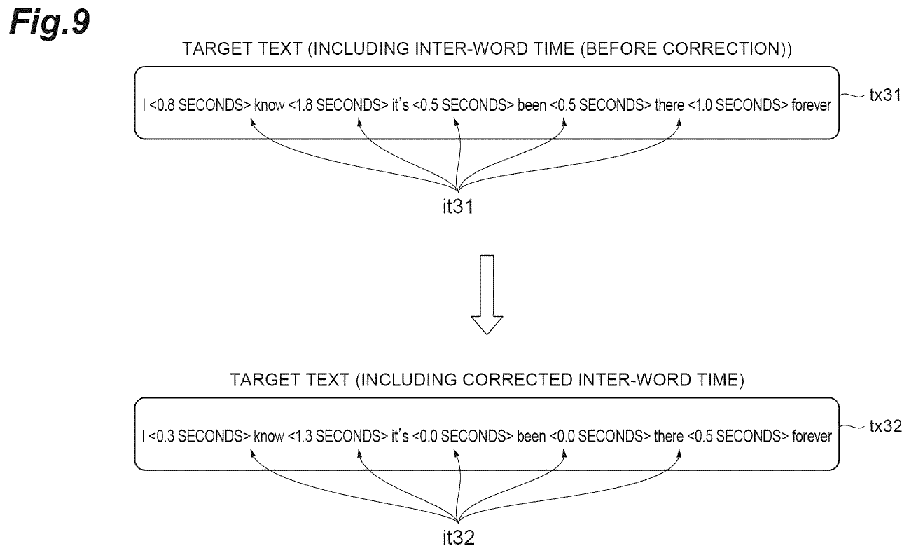

The delimiter insertion unit 13 may correct the inter-word time, which is to be used to adjust the delimiter prediction information, according to predetermined conditions. FIG. 9 is a diagram showing an example of processing for correcting the inter-word time. When the length of the inter-word time of one or more words among all words included in the target text is larger than a predetermined level, the delimiter insertion unit 13 may correct the inter-word time of each of all of the words to be as short as the predetermined level. Then, the delimiter insertion unit 13 may adjust the symbol insertion likelihood and/or the symbol absence likelihood based on the corrected inter-word time, which is the corrected inter-word time.

A target text tx31 shown in FIG. 9 includes an inter-word time it31 before correction. Here, as an example, it is assumed that the correction processing is set in advance to reduce the inter-word times of all words by 0.5 seconds when the inter-word times of a half or more of all words included in the target text are equal to or greater than the inter-word time corresponding to the inter-word time category “small”. In this case, the delimiter insertion unit 13 determines that the inter-word times of all words among the inter-word times it31 of words included in the target text tx31 are equal to or greater than the inter-word time corresponding to the inter-word time category “small”. Then, the delimiter insertion unit 13 subtracts 0.5 seconds from each of the inter-word times it31 as shown in the target text tx32 to obtain a corrected inter-word time it32, which is the inter-word time after correction. Based on the corrected inter-word time it32, the delimiter insertion unit 13 adjusts the symbol insertion likelihood and/or the symbol absence likelihood for each word included in the target text tx32.

When the speaker's speech tends to have long inter-word times overall, there is a possibility that delimiters will be inserted too much at positions unintended by the speaker in the text after insertion of the delimiters. However, according to the inter-word time correction processing described above, when the length of the inter-word time is larger than a predetermined level, the symbol insertion likelihood and/or the symbol absence likelihood are adjusted based on the corrected inter-word time that is corrected so that the inter-word time becomes shorter. Therefore, it is possible to obtain text in which delimiters are inserted at appropriate positions that appropriately reflect the speaker's intention.

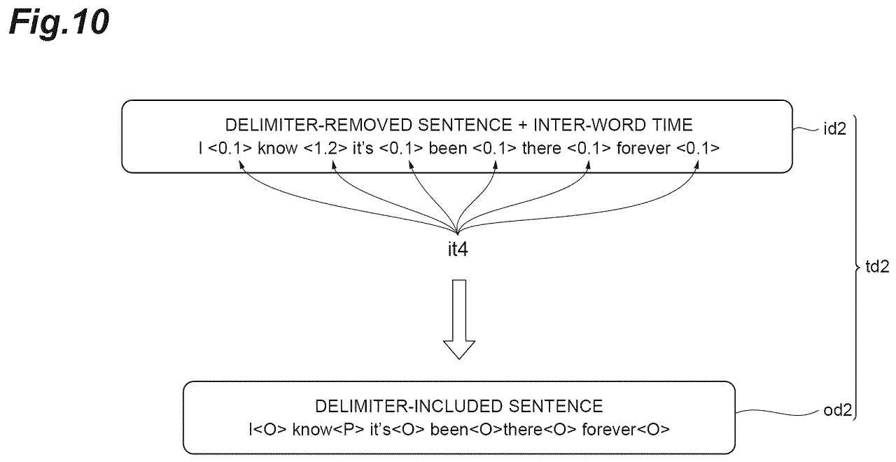

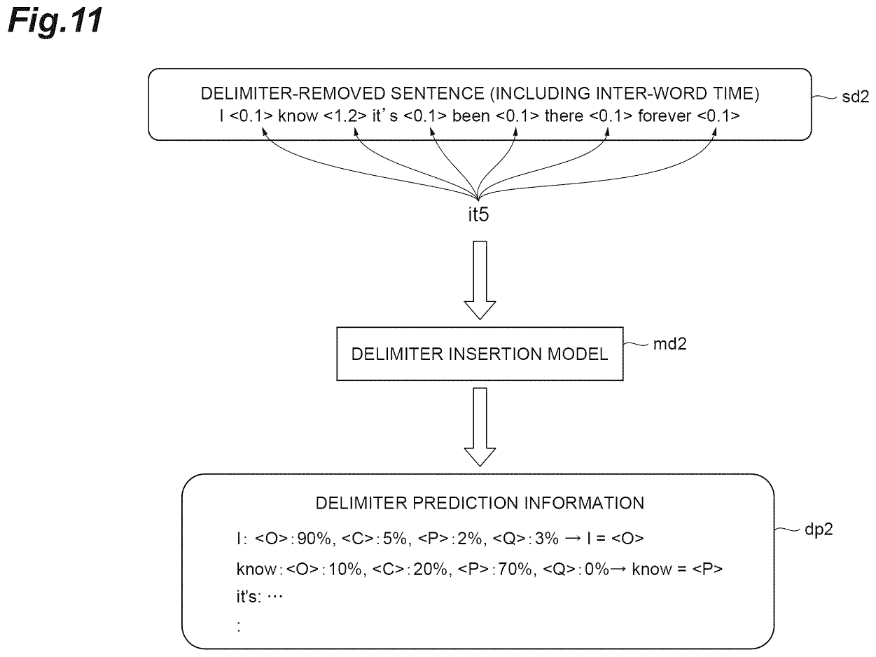

Next, a second example of the adjustment processing according to the inter-word time of the delimiter prediction information will be described. FIG. 10 is a diagram showing a second example of training data used for machine learning of the delimiter insertion model. FIG. 11 is a diagram showing a second example of the configuration of the delimiter insertion model.

As shown in FIG. 10, training data td2, which is an example of training data used for machine learning of a delimiter insertion model md2, includes a pair of a delimiter-removed sentence id2 and a delimiter-included sentence od2.

Similarly to the delimiter-included sentence od1 described with reference to FIG. 5, the delimiter-included sentence od2 includes a string of words that make up the sentence and delimiter labels indicating delimiters to be inserted after the respective words. The delimiter-removed sentence id2 includes a sentence, in which the delimiter labels have been removed from the delimiter-included sentence od2, and an inter-word times it4 associated with each of the words that make up the sentence.

In machine learning of the delimiter insertion model md2, the delimiter-removed sentence id2 is input to the delimiter insertion model md2 in the learning process, and the weights, parameters, and the like that make up the delimiter insertion model md2 are updated based on the error between the output obtained from the delimiter insertion model md2 and the delimiter-included sentence od2, which is teacher data.

The delimiter insertion model md2 may be a model including a neural network. More specifically, the delimiter insertion model md2 may be configured as a sequence labeling model that solves the sequence labeling task of predicting a delimiter to be inserted after each word included in the input sentence.

As shown in FIG. 11, the trained delimiter insertion model md2 outputs delimiter prediction information dp2 in response to the input of a delimiter-removed sentence sd2. The delimiter-removed sentence sd2 includes an inter-word time it5 associated with each word that makes up the delimiter-removed sentence sd2. The delimiter prediction information dp2 includes a symbol insertion likelihood and a symbol absence likelihood for each word included in the delimiter-removed sentence sd2.

The delimiter insertion model md2, which is a model including a trained neural network, can be read or referenced by a computer, and can be regarded as a program that causes the computer to perform predetermined processing and the computer to realize a predetermined function.

That is, the trained delimiter insertion model md2 of the present embodiment is used in a computer including a CPU and a memory. Specifically, in response to an instruction from the trained delimiter insertion model md2 stored in the memory, the CPU of the computer operates to perform a calculation on the input data input to the input layer of the neural network based on the trained weighting coefficients (parameters), response functions, and the like corresponding to each layer and to output the result (probability) from the output layer.

In the example described with reference to FIG. 6, the symbol insertion likelihood and the symbol absence likelihood included in the delimiter prediction information dp1 output from the delimiter insertion model md1 are adjusted based on the inter-word time. On the other hand, in the delimiter insertion model md2, the delimiter-removed sentence id2 including the inter-word time it4 is used for input as training data in machine learning, and the delimiter prediction information dp2 is output in response to the input of the delimiter-removed sentence sd2 including the inter-word time it5. Therefore, the symbol insertion likelihood and the symbol absence likelihood included in the delimiter prediction information dp2 are values adjusted according to the inter-word time by calculation in the delimiter insertion model md2.

In the delimiter insertion model md2, the symbol insertion likelihood and the symbol absence likelihood of each delimiter for the word “I” are calculated as follows.

$$< O > : 90 \% , < C > : 5 \% , < P > : 2 \% , < Q > : 3 \%$$

Therefore, the delimiter prediction information dp2 includes information (I=<O>) indicating that the label <O> of no delimiter, which has the maximum likelihood of the symbol insertion likelihood and the symbol absence likelihood of each delimiter for the word “I”, has been labeled for the word “I”. Then, the delimiter insertion unit 13 determines not to insert a delimiter after the word “I” included in the target text based on the labeled label <O>.

In addition, in the delimiter insertion model md2, the symbol insertion likelihood and the symbol absence likelihood of each delimiter for the word “know” are calculated as follows.

$$< O > : 10 \% , < C > : 20 \% , < P > : 70 \% , < Q > : 0 \%$$

In the delimiter prediction information dp1 illustrated in FIG. 6, the likelihood of no symbol being inserted (label <O>) is the maximum, whereas in each likelihood calculated by the delimiter insertion model md2, the symbol insertion likelihood of a period being inserted (label <P>) is the maximum. Therefore, the delimiter prediction information dp2 includes information (know=<P>) indicating that the insertion of a period has been labeled for the word “know”. Then, the delimiter insertion unit 13 inserts a period after the word “know” included in the target text based on the labeled label <P>.

Thus, the delimiter insertion model md2 is generated by machine learning in which delimiter-removed sentences with the inter-word time associated with each word are used as training data, and the delimiter-removed sentences including the inter-word time of each word are input to the delimiter insertion model md2. Therefore, by inputting the target text in which the inter-word time is associated with each word to the delimiter insertion model, it is possible to obtain delimiter prediction information adjusted based on the inter-word time without performing separate adjustment processing based on the inter-word time on the output from the delimiter insertion model. Then, by inserting delimiters into the target text based on the delimiter prediction information, it is possible to easily obtain the text in which delimiters are inserted at positions according to the speaker's intention.

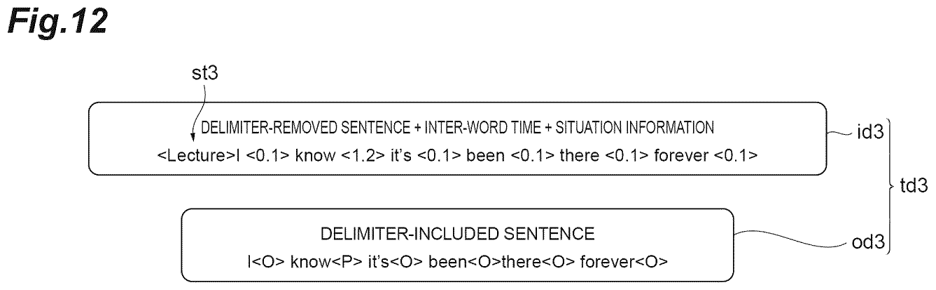

Next, another example of the delimiter insertion model will be described. FIG. 12 is a diagram showing a third example of training data used for machine learning of the delimiter insertion model. In the example shown in FIG. 12, training data td3 includes a pair of a delimiter-removed sentence id3 and a delimiter-included sentence od3.

Similarly to the delimiter-included sentences od1 and od2 described with reference to FIGS. 5 and 10, the delimiter-included sentence od3 includes a string of words that make up the sentence and delimiter labels indicating delimiters to be inserted after the respective words. The delimiter-removed sentence id3 includes situation information st3 in addition to a sentence in which the delimiter labels have been removed from the delimiter-included sentence od3 and the inter-word time associated with each of the words that make up the sentence. The situation information st3 is information indicating the situation when the speech was uttered, and may be added to the delimiter-removed sentence id3 as a tag.

The situation information st3 may have variations according to the situation when the speech was uttered, as follows.
Meeting: <Meeting>
Lecture: <Lecture>
Chatting: <Chatting>

In machine learning of the delimiter insertion model using the training data td3, the delimiter-removed sentence id3 is input to the delimiter insertion model in the learning process, and the weights, parameters, and the like that make up the delimiter insertion model are updated based on the error between the output obtained from the delimiter insertion model and the delimiter-included sentence od3, which is teacher data.

The delimiter insertion model trained by machine learning using the training data td3 outputs delimiter prediction information in response to the input of the delimiter-removed sentence (target text) including the situation information and the inter-word time associated with each word. The output delimiter prediction information includes the symbol insertion likelihood and the symbol absence likelihood for each word included in the delimiter-removed sentence and the delimiter based on the maximum likelihood or the label of no delimiter insertion.

Based on the delimiter prediction information obtained by inputting the target text associated with the situation information to the delimiter insertion model, the delimiter insertion unit 13 determines whether to insert a delimiter according to the label after each word or not to insert a delimiter.

Thus, a delimiter insertion model is generated by machine learning in which delimiter-removed sentences associated with situation information are used as training data, and the delimiter-removed sentences including the situation information are input to the delimiter insertion model. Therefore, by inputting the target text associated with the situation information to the delimiter insertion model, it is possible to obtain delimiter prediction information in which speech tendencies according to the situation when the speech is uttered have been taken into consideration.

Referring back to FIG. 1, the output unit 14 outputs a delimiter-inserted text, which is a target text into which delimiters have been inserted by the delimiter insertion unit 13. The output form is not limited, and the output unit 14 may display the delimiter-inserted text on a predetermined display means, may store the delimiter-inserted text in a predetermined storage means, or may transmit the delimiter-inserted text to a predetermined device.

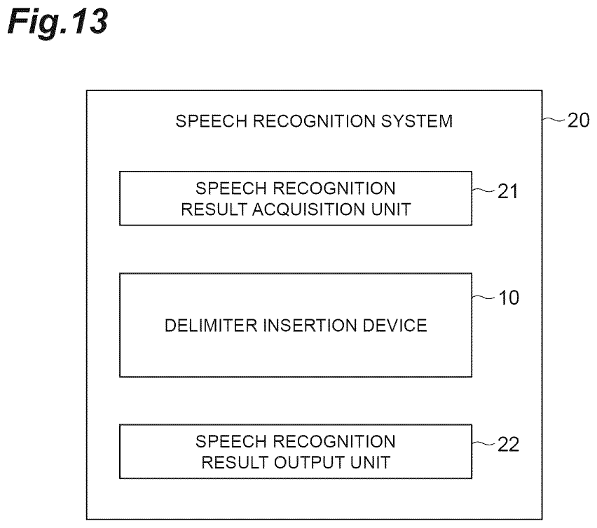

FIG. 13 is a functional block diagram showing an example of the configuration of a speech recognition system according to the present embodiment. As shown in FIG. 13, a speech recognition system 20 includes the delimiter insertion device 10, and includes a speech recognition result acquisition unit 21 and a speech recognition result output unit 22.

The speech recognition result acquisition unit 21 acquires, as a first speech recognition result, a text resulting from speech recognition by a speech recognition engine and the inter-word time of each word in the text.

The text acquisition unit 11 of the delimiter insertion device 10 acquires the text included in the first speech recognition result as a target text. The inter-word time acquisition unit 12 of the delimiter insertion device 10 acquires the inter-word time included in the first speech recognition result.

The delimiter insertion unit 13 of the delimiter insertion device 10 performs processing for inserting delimiters into the text included in the first speech recognition result as a target text.

The speech recognition result output unit 22 outputs, as a second speech recognition result, the target text in which the delimiters have been inserted by the delimiter insertion unit 13.

According to the speech recognition system 20, based on the first speech recognition result obtained from the speech recognition engine in which inter-word times are not taken into consideration in the speech recognition process, delimiter prediction information adjusted according to the inter-word times included in the first speech recognition result can be acquired with the text included in the first speech recognition result as a target text. Therefore, it is possible to obtain the second speech recognition result including the target text in which delimiters are inserted at positions according to the speaker's intention.

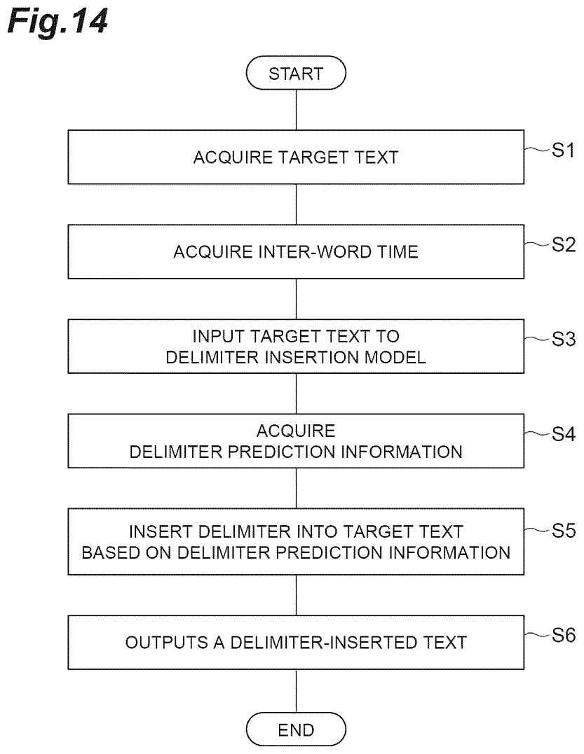

FIG. 14 is a flowchart showing the processing content of the delimiter insertion method in the delimiter insertion device 10.

In step S1, the text acquisition unit 11 acquires a target text, which is obtained by speech recognition of uttered speech and is a text into which a delimiter is to be inserted.

In step S2, the inter-word time acquisition unit 12 acquires the inter-word time of each word in the uttered speech.

In step S3, the delimiter insertion unit 13 inputs the target text to the delimiter insertion model.

In step S4, the delimiter insertion unit 13 acquires delimiter prediction information. The delimiter prediction information includes a label, which indicates whether to insert a delimiter or not to insert a delimiter for each word and which is based on the symbol insertion likelihood and the symbol absence likelihood for each word adjusted according to inter-word time.

In step S5, the delimiter insertion unit 13 inserts a delimiter into the target text based on the delimiter prediction information.

In step S6, the output unit 14 outputs a delimiter-inserted text, which is the target text into which the delimiter has been inserted.

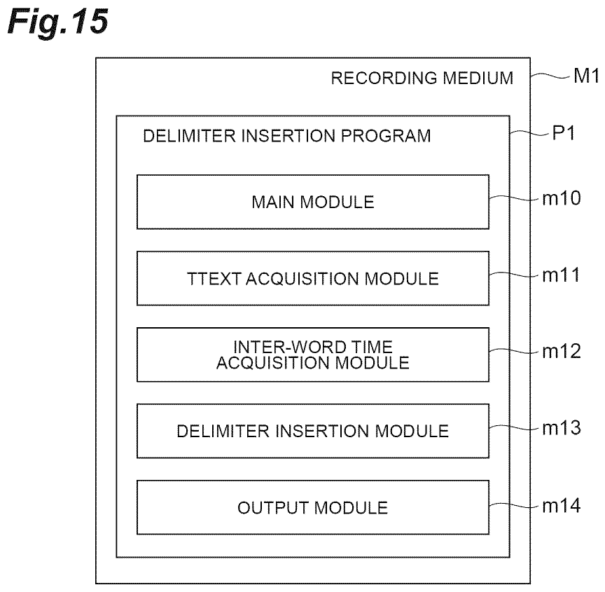

Next, a delimiter insertion program for causing a computer to function as the delimiter insertion device 10 according to the present embodiment will be described with reference to FIG. 15. FIG. 15 is a diagram showing the configuration of a delimiter insertion program. A delimiter insertion program P1 includes a main module m10 that performs overall control of delimiter insertion processing in the delimiter insertion device 10, a text acquisition module m11, an inter-word time acquisition module m12, a delimiter insertion module m13, and an output module m14. Then, respective functions of the text acquisition unit 11, the inter-word time acquisition unit 12, the delimiter insertion unit 13, and the output unit 14 are realized by the modules m 11 to m 14.

In addition, the delimiter insertion program P1 may be transmitted through a transmission medium such as a communication line, or may be stored in a recording medium M1 as shown in FIG. 15.

According to the delimiter insertion device 10, the delimiter insertion method, and the delimiter insertion program P1 according to the present embodiment described above, the inter-word time in the uttered speech is acquired. The inter-word time reflects the speaker's intention when speaking. Then, delimiter prediction information, which is obtained by inputting the target text to the delimiter insertion model and which is adjusted according to the inter-word information, is acquired. Since the delimiter prediction information acquired herein is information adjusted according to the inter-word time of each word in the uttered speech, the delimiter prediction information indicates delimiters reflecting the speaker's intention. Then, by inserting delimiters into the target text based on the delimiter prediction information, it is possible to obtain the text in which delimiters are inserted at positions according to the speaker's intention.

The invention according to the present disclosure can be understood as follows, for example.

A delimiter insertion device according to a first aspect of the present disclosure is a delimiter insertion device for inserting a delimiter to separate a sentence after a word included in a text obtained by speech recognition of uttered speech, and includes: an inter-word time acquisition unit that acquires an inter-word time, which is a length of time until a next word is spoken for each word included in the uttered speech; and a delimiter insertion unit that inserts a delimiter into a target text, which is a text obtained by speech recognition of the uttered speech, based on a delimiter insertion model and the inter-word time. The delimiter insertion model is a model that receives at least a delimiter-removed sentence, which is a sentence not including the delimiter, as an input, and outputs delimiter prediction information indicating a delimiter to be inserted after each word included in the delimiter-removed sentence and that is generated by machine learning using training data including a pair of the delimiter-removed sentence and a delimiter-included sentence, which is a sentence including a delimiter. The delimiter insertion unit inserts a delimiter into the target text based on the delimiter prediction information that is obtained by inputting the target text to the delimiter insertion model as the delimiter-removed sentence and has been adjusted according to the inter-word time.

According to the above aspect, the inter-word time in the uttered speech is acquired. The inter-word time reflects the speaker's intention when speaking. Then, the delimiter prediction information, which is obtained by inputting the target text to the delimiter insertion model and has been adjusted according to the inter-word information, is acquired. Since the delimiter prediction information acquired herein is information adjusted according to the inter-word time of each word in the uttered speech, the delimiter prediction information indicates delimiters reflecting the speaker's intention. Then, by inserting delimiters into the target text based on the delimiter prediction information, it is possible to obtain a text in which delimiters are inserted at positions according to the speaker's intention.

In a delimiter insertion device according to a second aspect, in the delimiter insertion device according to the first aspect, the delimiter insertion unit may adjust the delimiter prediction information output from the delimiter insertion model based on the inter-word time.

According to the above aspect, it is possible to reliably reflect the speaker's intention expressed by the inter-word time in the delimiter prediction information.

In a delimiter insertion device according to a third aspect, in the delimiter insertion device according to the second aspect, the delimiter prediction information may include a symbol insertion likelihood, which is a likelihood of inserting each of a plurality of kinds of delimiters after each word included in the delimiter-removed sentence, and a symbol absence likelihood, which is a likelihood of inserting no delimiter after each word. When the inter-word time of one of words included in the target text is a first time, the delimiter insertion unit may adjust the symbol absence likelihood for the one word to be increased and/or adjust the symbol insertion likelihood of at least one kind of delimiter, among a plurality of kinds of delimiters, for the one word to be decreased. When the inter-word time of the one word is a second time longer than the first time, the delimiter insertion unit may adjust the symbol insertion likelihood of at least one kind of delimiter, among a plurality of kinds of delimiters, for the one word to be increased and/or adjust the symbol absence likelihood for the one word to be increased. Based on a maximum likelihood of the symbol insertion likelihood and the symbol absence likelihood, the delimiter insertion unit may determine whether to insert one of the plurality of kinds of delimiters after the one word or insert no delimiter after the one word.

According to the above aspect, a relative adjustment is made such that the symbol insertion likelihood increases and/or the symbol absence likelihood decreases as the inter-word time of one word included in the target text increases, and a relative adjustment is made such that the symbol insertion likelihood decreases and/or the symbol absence likelihood increases as the inter-word time of one word decreases. Therefore, the speaker's intention is reflected in the symbol insertion likelihood and the symbol absence likelihood. Then, based on the adjusted symbol insertion likelihood and symbol absence likelihood, the delimiter is inserted or not inserted. Therefore, it is possible to obtain a text in which delimiters are inserted at appropriate positions according to the speaker's intention.

In a delimiter insertion device according to a fourth aspect, in the delimiter insertion device according to the third aspect, when a length of the inter-word time of one or more words among all words included in the target text is larger than a predetermined level, the delimiter insertion unit may adjust the symbol insertion likelihood and/or the symbol absence likelihood based on a corrected inter-word time obtained by correcting the inter-word time of each of all of the words to be as short as the predetermined level.

When the speaker's speech tends to have long inter-word times overall, there is a possibility that delimiters will be inserted too much at positions unintended by the speaker in the text after insertion of the delimiters. However, according to the above aspect, when the length of the inter-word time is larger than a predetermined level, the symbol insertion likelihood and/or the symbol absence likelihood are adjusted based on the corrected inter-word time that is corrected so that the inter-word time becomes shorter. Therefore, it is possible to obtain text in which delimiters are inserted at appropriate positions that appropriately reflect the speaker's intention.

In a delimiter insertion device according to a fifth aspect, in the delimiter insertion device according to the first aspect, the delimiter insertion model may further include, as an input, an inter-word time of each word included in the delimiter-removed sentence. The delimiter insertion model may be generated by machine learning using training data including a pair of the delimiter-included sentence and the delimiter-removed sentence in which the inter-word time is associated with each word. The delimiter insertion model may output the delimiter prediction information adjusted by the inter-word time. The delimiter insertion unit may input the target text, in which the inter-word time is associated with each word, to the delimiter insertion model.

According to the above aspect, the delimiter insertion model is generated by machine learning in which delimiter-removed sentences with the inter-word time associated with each word are used as training data, and the delimiter-removed sentences including the inter-word time of each word are input to the delimiter insertion model. Therefore, by inputting the target text in which the inter-word time is associated with each word to the delimiter insertion model, it is possible to obtain delimiter prediction information adjusted based on the inter-word time without performing separate adjustment processing based on the inter-word time on the output from the delimiter insertion model. Then, by inserting delimiters into the target text based on the delimiter prediction information, it is possible to easily obtain the text in which delimiters are inserted at positions according to the speaker's intention.

In a delimiter insertion device according to a sixth aspect, in the delimiter insertion device according to the fifth aspect, the delimiter prediction information may include a delimiter insertion likelihood, which is a likelihood of inserting each of a plurality of kinds of delimiters after each word included in the delimiter-removed sentence, and a symbol absence likelihood, which is a likelihood of inserting no delimiter after each word.

According to the above aspect, it is possible to obtain, for each word, delimiter prediction information including the symbol insertion likelihood and the symbol absence likelihood adjusted by the inter-word time. By inserting delimiters into the target text based on the adjusted symbol insertion likelihood and symbol absence likelihood, it is possible to easily obtain the text in which delimiters are inserted at positions according to the speaker's intention.

In a delimiter insertion device according to a seventh aspect, in the delimiter insertion device according to the fifth or sixth aspect, the delimiter insertion model may further include, as an input, situation information indicating a situation when speech corresponding to the delimiter-removed sentence is uttered. The delimiter insertion model may be generated by machine learning using training data including a pair of the delimiter-included sentence and the delimiter-removed sentence in which the inter-word time is associated with each word and with which the situation information is associated. The delimiter insertion unit may input the target text associated with the situation information to the delimiter insertion model.

According to the above aspect, the delimiter insertion model is generated by machine learning in which delimiter-removed sentences associated with situation information are used as training data, and the delimiter-removed sentences including the situation information are input to the delimiter insertion model. Therefore, by inputting the target text associated with the situation information to the delimiter insertion model, it is possible to obtain the delimiter prediction information in which speech tendencies according to the situation when the speech is uttered have been taken into consideration.

A speech recognition system according to a first aspect includes the delimiter insertion device according to any one of aspects 1 to 7, and includes: a speech recognition result acquisition unit that acquires, as a first speech recognition result, a text resulting from speech recognition by a speech recognition engine and the inter-word time of each word in the text; and a speech recognition result output unit. The inter-word time acquisition unit of the delimiter insertion device acquires the inter-word time included in the first speech recognition result, the delimiter insertion unit of the delimiter insertion device inserts a delimiter with a text included in the first speech recognition result as the target text, and the speech recognition result output unit outputs, as a second speech recognition result, the target text in which the delimiter has been inserted by the delimiter insertion unit.

According to the above aspect, based on the first speech recognition result obtained from the speech recognition engine in which inter-word times are not taken into consideration in the speech recognition process, the delimiter prediction information adjusted according to the inter-word times included in the first speech recognition result can be acquired with the text included in the first speech recognition result as a target text. Therefore, it is possible to obtain the second speech recognition result including the target text in which delimiters are inserted at positions according to the speaker's intention.

While the present embodiment has been described in detail, it is apparent to those skilled in the art that the present embodiment is not limited to the embodiments described in this specification. The present embodiment can be implemented as modified and changed aspects without departing from the spirit and scope of the present invention defined by the description of the claims. Therefore, the description of this specification is intended for illustrative purposes, and has no restrictive meaning to the present embodiment.

The notification of information is not limited to the aspects/embodiments described in the present disclosure, and may be performed using other methods. For example, the notification of information may be performed using physical layer signaling (for example, DCI (Downlink Control Information), UCI (Uplink Control Information)), higher layer signaling (for example, RRC (Radio Resource Control) signaling, MAC (Medium Access Control) signaling, broadcast information (MIB (Master Information Block), SIB (System Information Block))), other signals, or a combination thereof. In addition, the RRC signaling may be called an RRC message, and may be, for example, an RRC connection setup message or an RRC connection reconfiguration message.

Each aspect/embodiment described in the present disclosure may be applied to at least one of systems, which use LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi (registered trademark)), IEEE 802.16 (WiMAX), IEEE 802.20, UWB (Ultra-WideBand), Bluetooth (registered trademark), and other appropriate systems, and next-generation systems extended based on these. In addition, a plurality of systems may be combined (for example, a combination of 5G and at least one of LTE and LTE-A) to be applied.

In the processing procedure, sequence, flowchart, and the like in each aspect/embodiment described in this specification, the order may be changed as long as there is no contradiction. For example, for the methods described in this specification, elements of various steps are presented using an exemplary order. However, the present invention is not limited to the specific order presented.

In the present disclosure, a specific operation performed by the base station may be performed by its upper node in some cases. In a network including one or more network nodes each having a base station, it is obvious that various operations performed for communication with the terminal can be performed by at least one of the base station and other network nodes (for example, MME, S-GW, and the like can be considered, but the network node is not limited thereto) other than the base station. Although the case where the number of other network nodes other than the base station is one has been exemplified above, a combination (for example, MME and S-GW) of a plurality of other network nodes may be applied.

Information or the like (see the “information, signals” section) can be output from a higher layer (or a lower layer) to a lower layer (or a higher layer). Information or the like may be input and output through a plurality of network nodes.

Information or the like that is input and output may be stored in a specific place (for example, a memory) or may be managed using a management table. The information or the like that is input and output can be overwritten, updated, or added. The information or the like that is output may be deleted. The information or the like that is input may be transmitted to another device.

The judging may be performed based on a value (0 or 1) expressed by 1 bit, may be performed based on the Boolean value (Boolean: true or false), or may be performed by numerical value comparison (for example, comparison with a predetermined value).

Each aspect/embodiment described in the present disclosure may be used alone, may be used in combination, or may be switched and used according to execution. In addition, the notification of predetermined information (for example, notification of “X”) is not limited to being explicitly performed, and may be performed implicitly (for example, without the notification of the predetermined information).

While the present disclosure has been described in detail, it is apparent to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for illustrative purposes, and has no restrictive meaning to the present disclosure.

Software, regardless of whether this is called software, firmware, middleware, microcode, a hardware description language, or any other name, should be interpreted broadly to mean instructions, instruction sets, codes, code segments, program codes, programs, subprograms, software modules, applications, software applications, software packages, routines, subroutines, objects, executable files, execution threads, procedures, functions, and the like.

In addition, software, instructions, and the like may be transmitted and received through a transmission medium. For example, in a case where software is transmitted from a website, a server, or other remote sources using wired technology such as a coaxial cable, an optical fiber cable, a twisted pair, and a digital subscriber line (DSL) and/or wireless technology such as infrared, wireless, and microwave, these wired technology and/or wireless technology is included within the definition of the transmission medium.

The information, signals, and the like described in the present disclosure may be expressed using any of a variety of different technologies. For example, data, instructions, commands, information, signals, bits, symbols, and chips that can be referred to throughout the above description may be represented by voltage, current, electromagnetic waves, magnetic field or magnetic particles, light field or photon, or any combination thereof.

In addition, the terms described in the present disclosure and/or the terms necessary for understanding this specification may be replaced with terms having the same or similar meaning.

The terms “system” and “network” used in this specification are used interchangeably.

In addition, the information, parameters, and the like described in this specification may be expressed using an absolute value, may be expressed using a relative value from a predetermined value, or may be expressed using another corresponding information. For example, the radio resources may be indicated by an index.

The names used for the parameters described above are not limiting names in any way. In addition, equations and the like using these parameters may be different from those explicitly disclosed in the present disclosure. Since various channels (for example, a PUCCH and a PDCCH) and information elements can be identified by any suitable names, various names allocated to these various channels and information elements are not limiting names in any way.

The term “determining” used in the present disclosure may involve a wide variety of operations. For example, “determining” can include considering judging, calculating, computing, processing, deriving, investigating, looking up (search, inquiry) (for example, looking up in a table, database, or another data structure), and ascertaining as “determining”. In addition, “determining” can include considering receiving (for example, receiving information), transmitting (for example, transmitting information), input, output, and accessing (for example, accessing data in a memory) as “determining”. In addition, “determining” can include considering resolving, selecting, choosing, establishing, comparing, and the like as “determining”. In other words, “determining” can include considering any operation as “determining”. In addition, “determining” may be read as “assuming”, “expecting”, “considering”, and the like.

The description “based on” used in the present disclosure does not mean “based only on” unless otherwise specified. In other words, the description “based on” means both “based only on” and “based at least on”.

When terms such as “first” and “second” are used in this specification, any reference to the elements does not generally limit the quantity or order of the elements. These designations can be used in this specification as a convenient method for distinguishing between two or more elements. Therefore, references to first and second elements do not mean that only the two elements can be adopted or that the first element should precede the second element in any way.

As long as the words “include”, “including”, and variations thereof are used in this specification or claims, these terms are intended to be inclusive similarly to the term “comprising”. In addition, the term “or” used in this specification or claims is intended not to be an exclusive-OR.

In the present disclosure, in a case where articles, for example, a, an, and the in English, are added by translation, the present disclosure may include that nouns subsequent to these articles are plural.

In the present disclosure, the expression “A and B are different” may mean “A and B are different from each other”. In addition, the expression may mean that “A and B each are different from C”. Terms such as “separate” and “coupled” may be interpreted similarly to “different”.

### REFERENCE SIGNS LIST

10: delimiter insertion device, 11: target text acquisition unit, 12: inter-word time acquisition unit, 13: delimiter insertion unit, 14: output unit, 20: speech recognition system, 21: speech recognition result acquisition unit, 22: speech recognition result output unit, M1: recording medium, m10: main module, m11: target text acquisition module, m12: inter-word time acquisition module, m13: delimiter insertion module, m14: output module, md1, md2: delimiter insertion model.

1. A delimiter insertion device for inserting a delimiter to separate a sentence after a word included in a text obtained by speech recognition of uttered speech, comprising:
an inter-word time acquisition unit that acquires an inter-word time, which is a length of time until a next word is spoken for each word included in the uttered speech; and
a delimiter insertion unit that inserts a delimiter into a target text, which is a text obtained by speech recognition of the uttered speech, based on a delimiter insertion model and the inter-word time,
wherein the delimiter insertion model is a model that receives at least a delimiter-removed sentence, which is a sentence not including the delimiter, as an input, and outputs delimiter prediction information indicating a delimiter to be inserted after each word included in the delimiter-removed sentence and that is generated by machine learning using training data including a pair of the delimiter-removed sentence and a delimiter-included sentence, which is a sentence including a delimiter, and
the delimiter insertion unit inserts a delimiter into the target text based on the delimiter prediction information that is obtained by inputting the target text to the delimiter insertion model as the delimiter-removed sentence and has been adjusted according to the inter-word time.

2. The delimiter insertion device according to claim 1,
wherein the delimiter insertion unit adjusts the delimiter prediction information output from the delimiter insertion model based on the inter-word time.

3. The delimiter insertion device according to claim 2,
wherein the delimiter prediction information includes a symbol insertion likelihood, which is a likelihood of inserting each of a plurality of kinds of delimiters after each word included in the delimiter-removed sentence, and a symbol absence likelihood, which is a likelihood of inserting no delimiter after each word,
when the inter-word time of one of words included in the target text is a first time, the delimiter insertion unit adjusts the symbol absence likelihood for the one word to be increased and/or adjusts the symbol insertion likelihood of at least one kind of delimiter, among a plurality of kinds of delimiters, for the one word to be decreased,
when the inter-word time of the one word is a second time longer than the first time, the delimiter insertion unit adjusts the symbol insertion likelihood of at least one kind of delimiter, among a plurality of kinds of delimiters, for the one word to be increased and/or adjusts the symbol absence likelihood for the one word to be increased, and
based on a maximum likelihood of the symbol insertion likelihood and the symbol absence likelihood, the delimiter insertion unit determines whether to insert one of the plurality of kinds of delimiters after the one word or insert no delimiter after the one word.

4. The delimiter insertion device according to claim 3,
wherein, when a length of the inter-word time of one or more words among all words included in the target text is larger than a predetermined level, the delimiter insertion unit adjusts the symbol insertion likelihood and/or the symbol absence likelihood based on a corrected inter-word time obtained by correcting the inter-word time of each of all of the words to be as short as the predetermined level.

5. The delimiter insertion device according to claim 1,
wherein the delimiter insertion model further includes, as an input, an inter-word time of each word included in the delimiter-removed sentence,
the delimiter insertion model is generated by machine learning using training data including a pair of the delimiter-included sentence and the delimiter-removed sentence in which the inter-word time is associated with each word,
the delimiter insertion model outputs the delimiter prediction information adjusted by the inter-word time, and
the delimiter insertion unit inputs the target text, in which the inter-word time is associated with each word, to the delimiter insertion model.

6. The delimiter insertion device according to claim 5,
wherein the delimiter prediction information includes a delimiter insertion likelihood, which is a likelihood of inserting each of a plurality of kinds of delimiters after each word included in the delimiter-removed sentence, and a symbol absence likelihood, which is a likelihood of inserting no delimiter after each word.

7. The delimiter insertion device according to claim 5,
wherein the delimiter insertion model further includes, as an input, situation information indicating a situation when speech corresponding to the delimiter-removed sentence is uttered,
the delimiter insertion model is generated by machine learning using training data including a pair of the delimiter-included sentence and the delimiter-removed sentence in which the inter-word time is associated with each word and with which the situation information is associated, and
the delimiter insertion unit inputs the target text associated with the situation information to the delimiter insertion model.

8. A speech recognition system including the delimiter insertion device according to claim 1, comprising:
a speech recognition result acquisition unit that acquires, as a first speech recognition result, a text resulting from speech recognition by a speech recognition engine and the inter-word time of each word in the text; and
a speech recognition result output unit,
wherein the inter-word time acquisition unit of the delimiter insertion device acquires the inter-word time included in the first speech recognition result,
the delimiter insertion unit of the delimiter insertion device inserts a delimiter with a text included in the first speech recognition result as the target text, and
the speech recognition result output unit outputs, as a second speech recognition result, the target text in which the delimiter has been inserted by the delimiter insertion unit.
